(19) United States
(12) Patent Application Publication
(10) Pub. No.: US 2009/0194182 A1
(43) Pub. Date: Aug. 6, 2009

(54) DUAL CHAMBER ORIFICE FITTING BODY

(75) Inventor: Thomas Henry Loga, Sugar Land, TX (US)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 12/023,511

(22) Filed: Jan. 31, 2008

(51) Int. Cl. F15D 1/00; F15D 1/02; F16K 3/00

(52) U.S. Cl. 138/44; 137/599.11; 251/326; 251/205; 137/315.27; 138/94; 138/94.3

(57) ABSTRACT

A dual chamber orifice fitting, including a body with a lower chamber in fluid communication with a pipeline and a top with an upper chamber in fluid communication with the lower chamber. A valve assembly closes to hydraulically isolate the upper chamber from the lower chamber and opens to allow an orifice plate carrier to move between the chambers. When the orifice plate carrier is in the lower chamber is can be aligned with the flowbore of the pipeline. The orifice plate carrier can be removed from the fitting through the upper chamber. In some embodiments, at least one of either the upper or lower chambers has a curved cross-section including inner and outer radii, a Cassini oval or a dog-bone shape. The body and top may also have a double curved outer surface to accommodate the curved cross-section of the interior chambers.

### BACKGROUND

The invention relates to apparatus for monitoring characteristics of a flow stream in a pipeline and in particular to dual chamber orifice fittings. More precisely, embodiments of the invention relate to an improved body design for dual chamber orifice fittings.

In pipeline operations and other industrial applications, flow meters are used to measure the volumetric flow rate of a gaseous or liquid flow stream moving through a piping section. Flow meters are available in many different forms. One common flow meter is an orifice meter, which includes an orifice fitting connected to the piping section. The orifice fitting serves to orient and support an orifice plate that extends across the piping section perpendicular to the direction of flow stream. The orifice plate is generally a thin plate that includes a circular opening, or orifice, that is typically positioned concentric with the flow stream.

In operation, when the flow stream moving through the piping section reaches the orifice plate, the flow is forced through the orifice, thereby constricting the cross-sectional flow area of the flow. Due to the principles of continuity and conservation of energy, the velocity of the flow increases as the stream moves through the orifice. This velocity increase creates a pressure differential across the orifice plate. The measured differential pressure across the orifice plate can be used to calculate the volumetric flow rate of the flow stream moving through the piping section.

A dual chamber orifice fitting embodies a special design that enables the orifice plate to be removed from the fitting without interrupting the flow stream moving through the piping section. This specially designed fitting has been known in the art for many years. U.S. Pat. No. 1,996,192, was issued in 1934 and describes an early dual chamber orifice fitting. Fittings with substantially the same design are still in use in many industrial applications today. Although the design has remained substantially unchanged, operating conditions continue to expand and dual chamber fittings are now available for piping sizes up to 48-inches in diameter and for working pressures up to 10,000 psi.

A common dual chamber orifice fitting 12 is illustrated in FIG. 1. Orifice fitting 12 includes body 16 and top 18. Body 16 encloses lower chamber 20 which is in fluid communication with the interior 34 of pipeline. Top 18 encloses upper chamber 22 and is connected to body 16 by bolts 17. Aperture 30 defines an opening connecting upper chamber 22 to lower chamber 20. Valve seat 24 is typically connected to top 18 and provides a sealing engagement with slide valve plate 56, which is slidably actuated by rotating gear shaft 54. Lower drive 36 and upper drive 38 operate to move orifice plate carrier 32 vertically within fitting 12.

Orifice plate carrier 32 is shown in a metering position in alignment with bore 34. To remove orifice plate carrier 32 from fitting 12 the following steps are used. First, gear shaft 54 is rotated to slide valve plate 56 laterally and away from valve seat 24 and open aperture 30. Once aperture 30 is opened, lower drive 36 is actuated to move orifice plate carrier 32 upwards into upper chamber 22. Once orifice plate carrier 32 is entirely within upper chamber 22, aperture 30 is closed to isolate the upper chamber from bore 34 and lower chamber 20. Any pressure within upper chamber 20 can then be relieved and orifice plate carrier 32 can be removed from fitting 12 by loosening clamping bar screws 46 and removing clamping bar 44 and sealing bar 40 from top 18.

Upper chamber 22 and lower chamber 20 are sized so as to accommodate upper drive 38 and lower drive 36 in order to allow orifice plate carrier 32 to move vertically. Lower chamber 20 must also accommodate the horizontal translation of slide valve plate 56. In order to accommodate these components, lower chamber 20 and upper chamber 22 are constructed as generally rectangular cross-sectioned cavities within body 16 and top 18. The general shape of the cavities is commonly formed during the casting process used to make the top or body components. Because of their size and complexity, these castings are often the most expensive components of a dual chamber orifice fitting.

Another improved dual chamber orifice fitting 100 is illustrated in FIGS. 2 and 3, and further described and shown in U.S. Pat. No. 7,063,107. Fitting 100 includes body 110 and top 115 connected by bolts 117. Body 110 encloses lower chamber 120 and provides fluid communication with the interior of the pipeline by way of flange 125. Plug 155 seals the lower end of body 110. Top 115 encloses upper chamber 130 and includes aperture 140, which provides a passageway between the upper chamber and lower chamber 120. Valve assembly 135 is used to open and close the aperture 140.

Orifice plate carrier 147 supports the orifice plate 149. Upper drive assembly 145 and lower drive assembly 150 are used to move orifice plate carrier 147 between lower chamber 120 and upper chamber 130.

Top 115 includes flange 160, for connecting with body 110, and wall 165 surrounding upper chamber 130. Upper chamber 130 is isolated from atmospheric pressure by sealing bar 170 and sealing bar gasket 172, which are retained with clamping bar 175 and clamping bar screws 177. Wall 165 supports upper drive assembly 145 and includes port 185, which provides access to upper chamber 130.

Referring now to FIGS. 4 and 5, an isometric cross-section view of fitting 100 is shown. The internal components have been removed so that the features of body 110 and top 115 can be seen. Top 115 includes upper chamber 130 with curved wall 165. Curved wall 165 gives upper chamber 130 an elliptical cross-section, as shown in the cross-section view of FIG. 5 taken along section 5-5 of FIG. 3. The exterior shape of wall 165 closely follows the shape of upper chamber 130 providing a substantially constant wall thickness surrounding the chamber. Wall 165 extends into flange 160 having bolt pattern 190. Bolt pattern 190 is spaced so as to allow access to bolts 117 attaching top 115 to body 110, which has a corresponding bolt pattern.

FIG. 5 illustrates the elliptical shape that upper chamber 130 and wall 165 may take. The elliptical shape includes a major axis A and a minor axis B, creating an overall width W of top 115 at flange 160.

Improvements that decrease the weight of the top and body components or the processing required in producing these components can result in significant savings in the overall cost of producing the fitting. Reducing the size, width or footprint of the top and body components can also produce these results, while also producing a smaller and more manageable fitting. Therefore, the embodiments described herein are directed to apparatus for dual chamber orifice fittings that seek to overcome these and other limitations of the prior art.

### SUMMARY

A dual chamber orifice fitting comprising a body with a lower chamber in fluid communication with a pipeline and a top with an upper chamber in fluid communication with the lower chamber. In some embodiments, an upper flange on the top portion couples to a lower flange on the body portion. A valve assembly closes in order to hydraulically isolate the upper chamber from the lower chamber and opens to allow an orifice plate carrier to move between the chambers. When the orifice plate carrier is in the lower chamber it can be aligned with the flowbore of the pipeline. The orifice plate carrier can be removed from the fitting through the upper chamber. In some embodiments, at least one of either the upper or lower chamber has a cross-section with both an inner radius and an outer radius. In other embodiments, the cross-section includes an oval, a Cassini oval or a dog-bone shape. In further embodiments, the lower and upper chambers may have a double curved wall, and the body and top may also have a curved outer surface to accommodate the double curved walls of the interior chambers. In certain embodiments, the lower and upper flanges include bolt patterns corresponding with the inner and outer radii, the curved outer surfaces of the body and top, or other curved shapes described herein.

In some embodiments, a fitting comprises a body portion having a lower chamber in fluid communication with a pipeline and a top portion having an upper chamber in fluid communication with the lower chamber. The fitting may have an upper flange on the top portion coupled to a lower flange on the body portion. At least a portion of either the upper chamber or the lower chamber has a cross-section including a Cassini oval.

In certain embodiments, a fitting comprises a body portion having a lower chamber in fluid communication with a pipeline and a top portion having an upper chamber in fluid communication with the lower chamber. The fitting may have an upper flange on the top portion coupled to a lower flange on the body portion. At least a portion of either the upper chamber or the lower chamber has a cross-section including a dog-bone shape.

Thus, the embodiments herein comprise a combination of features and advantages that enable substantial enhancement of the operation of dual chamber orifice fittings. These and various other characteristics and advantages of the present invention will be readily apparent to those skilled in the art upon reading the following detailed description of the embodiments and by referring to the accompanying drawings.

### BRIEF DESCRIPTION OF THE DRAWINGS

For a more detailed understanding of the present invention, reference is made to the accompanying Figures, wherein:

FIG. 1 is a partial sectional isometric view of a prior art dual chamber orifice fitting;

FIG. 2 is an isometric view of another dual chamber orifice fitting;

FIG. 3 is a cross-sectional elevation view of the fitting of FIG. 2;

FIG. 4 is a partial sectional isometric view of the fitting of FIG. 2;

FIG. 5 is a cross-sectional view of the fitting of FIG. 2 taken at the section 5-5 of FIG. 3;

FIG. 6 is an isometric view of a dual chamber orifice fitting in accordance with embodiments of the invention;

FIG. 7 is a cross-sectional view of the fitting of FIG. 6 taken at a section of the fitting similar to the section 5-5 of FIG. 3;

FIG. 8 is a partial sectional isometric view of the fitting of FIG. 6;

FIG. 9 is a partial sectional isometric view of the top of FIG. 6;

FIG. 10 is a partial sectional isometric view of an alternate dual chamber orifice fitting in accordance with embodiments of the invention;

FIG. 11 is a partial sectional isometric view of the body of FIG. 10;

FIG. 12 is an isometric view of another alternate dual chamber orifice fitting in accordance with embodiments of the invention; and

FIG. 13 is a cross-sectional elevation view of the fitting of FIG. 12.

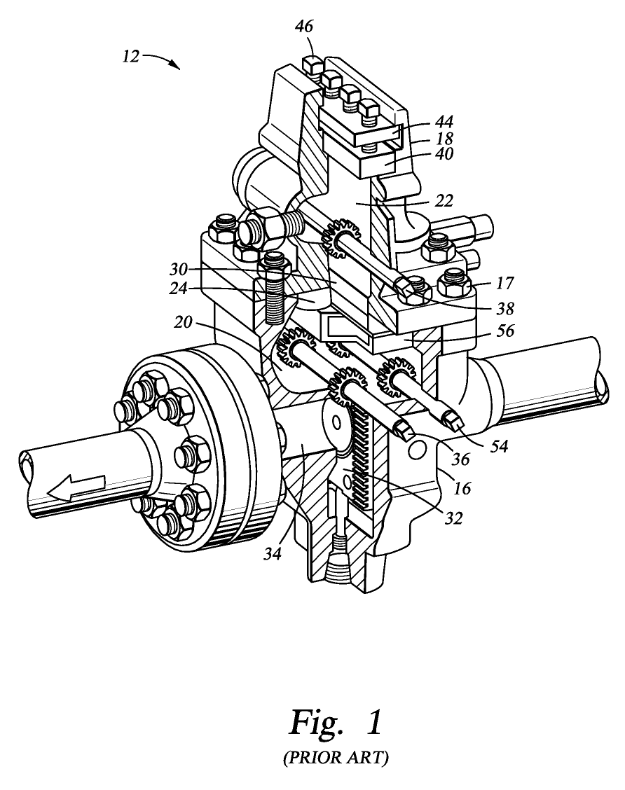

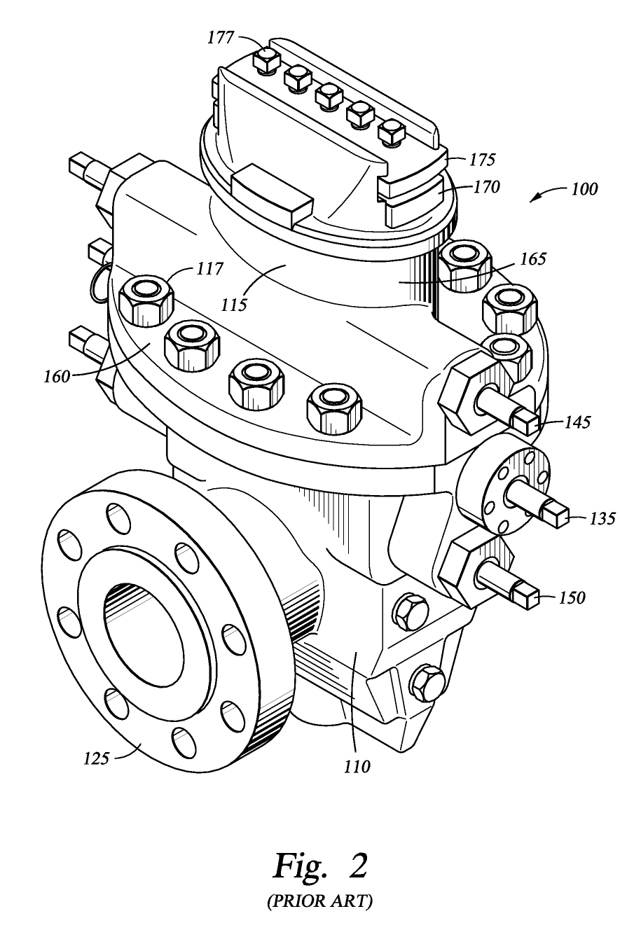

### DETAILED DESCRIPTION

In the drawings and description that follow, like parts are typically marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results.

Unless otherwise specified, any use of any form of the terms “connect”, “engage”, “couple”, “attach”, or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. The various characteristics mentioned above, as well as other features and characteristics described in more detail below, will be readily apparent to those skilled in the art upon reading the following detailed description of the embodiments, and by referring to the accompanying drawings.

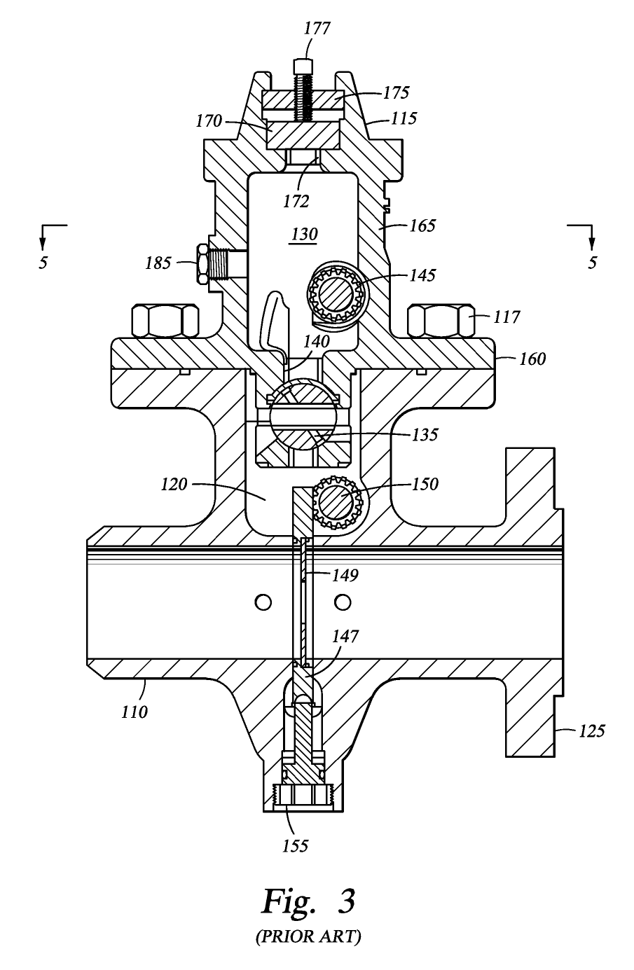

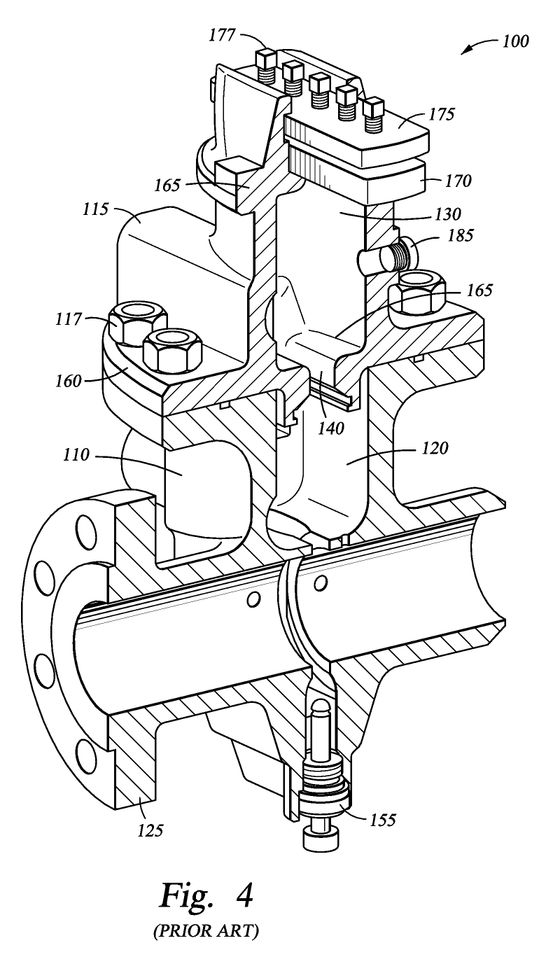

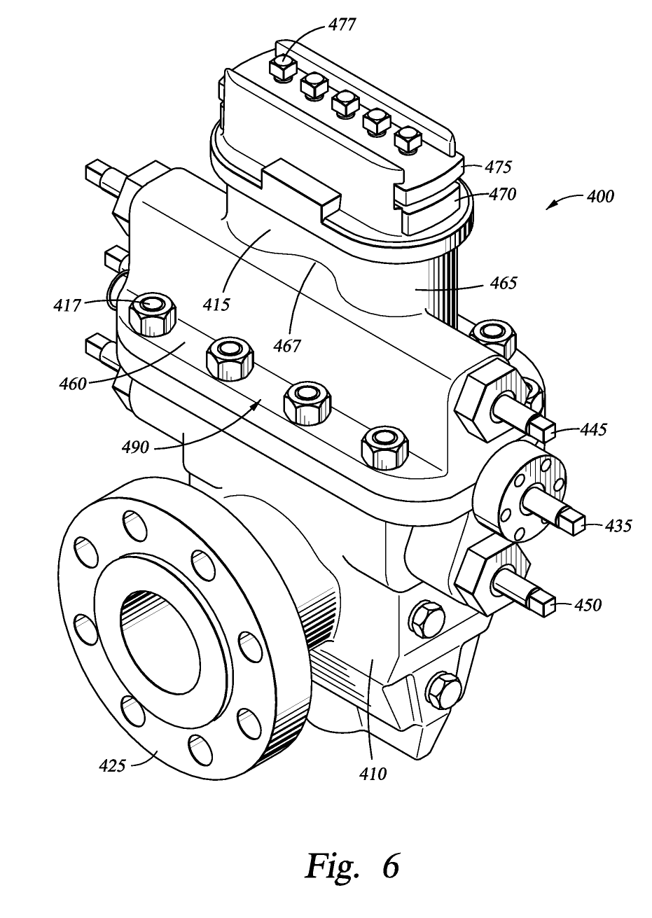

Referring now to FIGS. 6, 7 and 8, one embodiment of a dual chamber orifice fitting 400 is shown. Fitting 400 includes body 410 and top 415 connected by bolts 417. Body 410 encloses lower chamber 420 and provides fluid communication with the interior of the pipeline by way of flange 425. Plug 455 seals the lower end of body 410. Top 415 encloses upper chamber 430 and includes aperture 440, which provides a passageway between the upper chamber and lower chamber 420. A valve assembly, such as assembly 135 in FIG. 3, is used to open and close the aperture 440. One preferred valve assembly is described in U.S. Pat. No. 7,104,521, entitled “Dual Chamber Orifice Fitting Valve.”

Referring back to FIG. 3, like fitting 100, fitting 400 may include orifice plate carrier 147 that supports the orifice plate 149. Upper drive assembly 145 and lower drive assembly 150 are used to move orifice plate carrier 147 between lower chamber 120 and upper chamber 130, or lower chamber 420 and upper chamber 430 of fitting 400. One preferred orifice plate carrier assembly is described in U.S. patent application Ser. No. 10/849,087, entitled “Dual Chamber Orifice Fitting Plate Support.”

Top 415 includes flange 460, for connecting with body 410, and wall 465 surrounding upper chamber 430. Upper chamber 430 is isolated from atmospheric pressure by sealing bar 470 and sealing bar gasket 472, which are retained with clamping bar 475 and clamping bar screws 477. Wall 465 supports an upper drive assembly, such as the assembly 145 of FIG. 3, and includes port 485, which provides access to upper chamber 430.

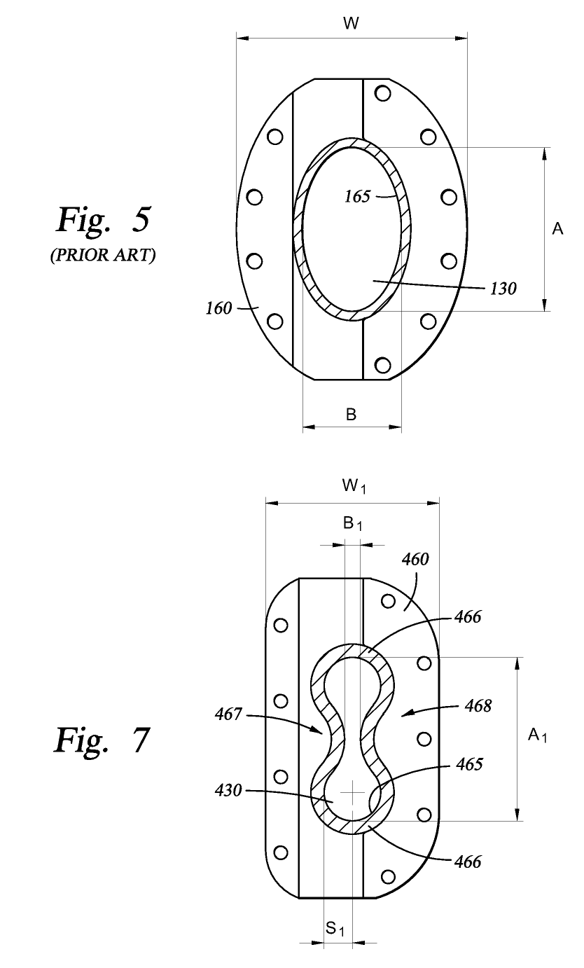

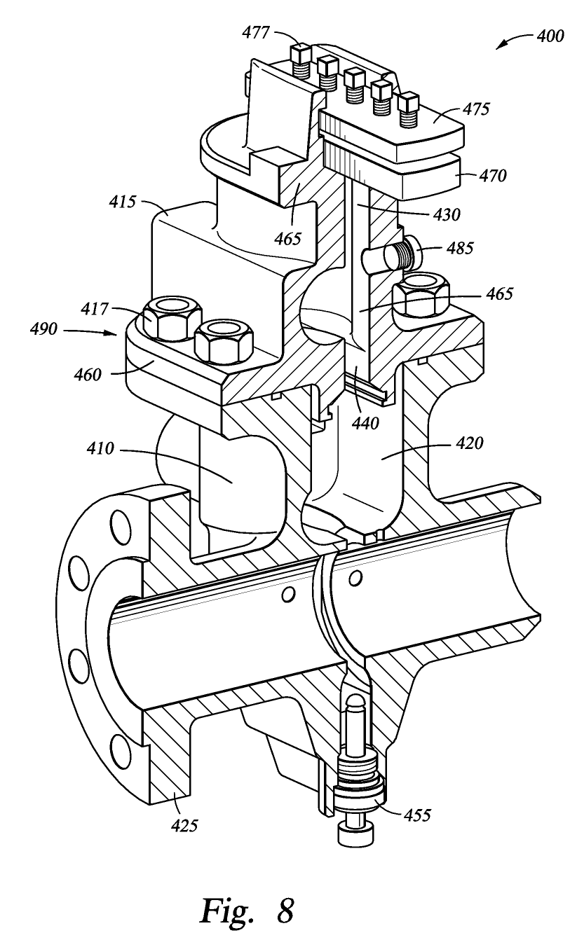

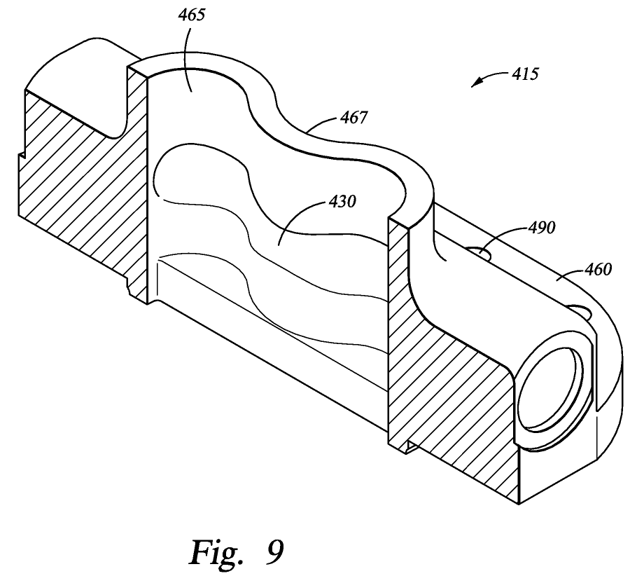

FIG. 8 shows an isometric cross-section view of fitting 400. The internal components have been removed so that the features of body 410 and top 415 can be seen. Top 415 includes upper chamber 430 with curved wall 465. Curved wall 465 gives upper chamber 430 a certain unique cross-section, as shown in FIG. 7 which is a cross-section of fitting 400 comparable to the cross-section shown in FIG. 5 of fitting 100. Also, a portion of upper chamber 430 is shown in the partial sectional isometric view of FIG. 9. The exterior shape of wall 465 closely follows the shape of upper chamber 430, as partially represented by the recessed portion 467 of FIGS. 6 and 9, providing a substantially constant wall thickness surrounding the chamber. Wall 465 is supported by flange 460 having bolt pattern 490. Bolt pattern 490 is spaced so as to allow access to bolts 417 attaching top 415 to body 410, which has a corresponding bolt pattern.

Referring now to FIG. 7, the cross-section of chamber 430 more clearly shows the cross-sectional shape of chamber 430 and wall 465. In some embodiments, wall 465, supported by flange 460, includes a curve having end curves 466 each with an inner radius of curvature (because the center of curvature lies within wall 465) and middle curves at recessed portions 467 each with an outer radius of curvature (because the center of curvature lies outside wall 465). In other embodiments, the curve is a Cassini oval including a major axis A₁ and a minor axis B₁. Each half of minor axis B₁ lying on either side of major axis A₁ is also known as a semi-minor axis. A distance extending perpendicularly from major axis A₁ to a point on the Cassini oval is known as a semi-latus rectum, and the greatest semi-latus recti on each side of minor axis B₁ is represented at S₁. In one embodiment, the curve or oval of wall 465 is characterized as having a semi-minor axis that is less than the greatest semi-latus rectum S₁. In a further embodiment, such a semi-latus rectum S₁ is disposed in each side of the minor and semi-minor axis as shown in FIG. 7. In another embodiment, the curve is characterized as a dog-bone shape because of the curve's resemblance to a dog bone. In other embodiments, the curve is characterized as having double curvature due to the opposing curves having inner and outer radii of curvature. In one aspect, the curve of wall 465 may be thought of as an oval as shown in FIG. 5 wherein the middle curves at the ends of minor axis B are flipped over or turned inward as shown in FIG. 7.

In many of the embodiments just described, the curvature of wall 465 reduces the overall width of the curve as compared to FIG. 7, thereby also allowing reduction of the overall width W₁ of flange 460 as compared to width W of flange 160 of FIG. 7. This decreases the weight of top 415 and simplifies the processing required in producing top 415, resulting in significant savings in the overall cost of producing the fitting. Reducing the width or footprint of top 415 produces a smaller and more manageable fitting 400, while creating little or no loss of strength in wall 465 and continuing to reduce high stresses in the corner areas of typical rectangular configurations.

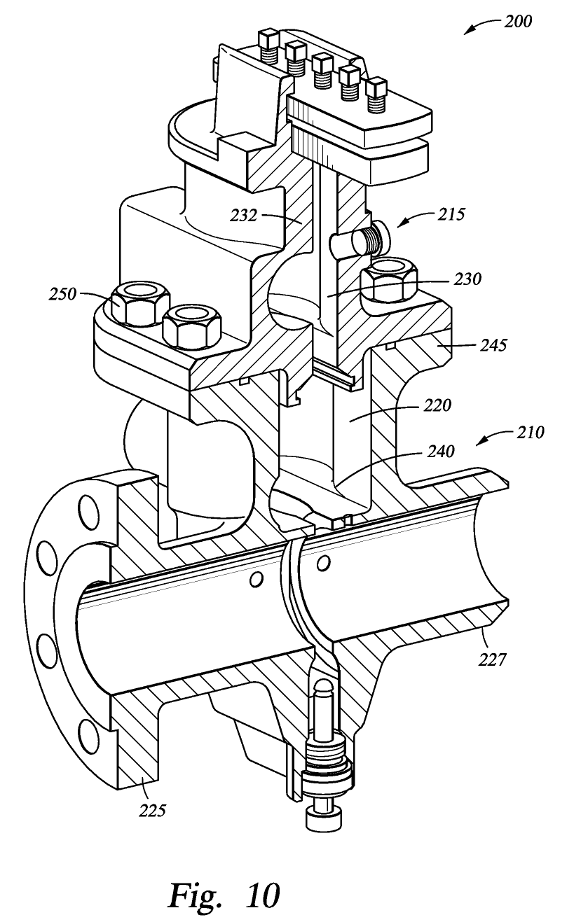

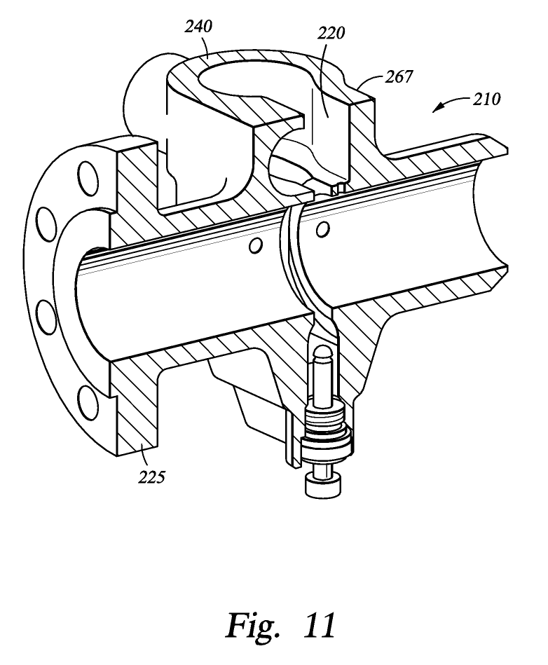

Referring now to FIG. 10, an alternate embodiment of fitting 200 is shown having a body 210 and top 215. Top 215 encloses upper chamber 230, which has a curved cross-section and curved wall 232 such as those described in reference to FIGS. 6-9. Body 210 includes lower chamber 220, which has a curved cross-section and a curved wall 240. Body 210 provides fluid communication with the interior of the pipeline by way of flange 225 and weld neck 227. Similar to body 410 described above, body 210 is adapted to support a lower drive mechanism (not shown) and valve assembly (not shown), but supports these components in a lower chamber 220 with a curved wall 240. Lower chamber 220 accommodates a standard rectangular orifice plate carrier with a chamber having a curved cross-section, a portion of which is shown in FIG. 11. In some embodiments, the curved cross-section of wall 240 includes an inner radius of curvature and an outer radius of curvature. In other embodiments, the curve is a Cassini oval. In another embodiment, the curve is characterized as a dog-bone shape. In other embodiments, the curve is characterized as having double curvature due to the opposing curves having inner and outer radii of curvature. In some embodiments, wall 240 has a substantially constant thickness, creating a body 210 that has a double curved outer shape surrounding lower chamber 220.

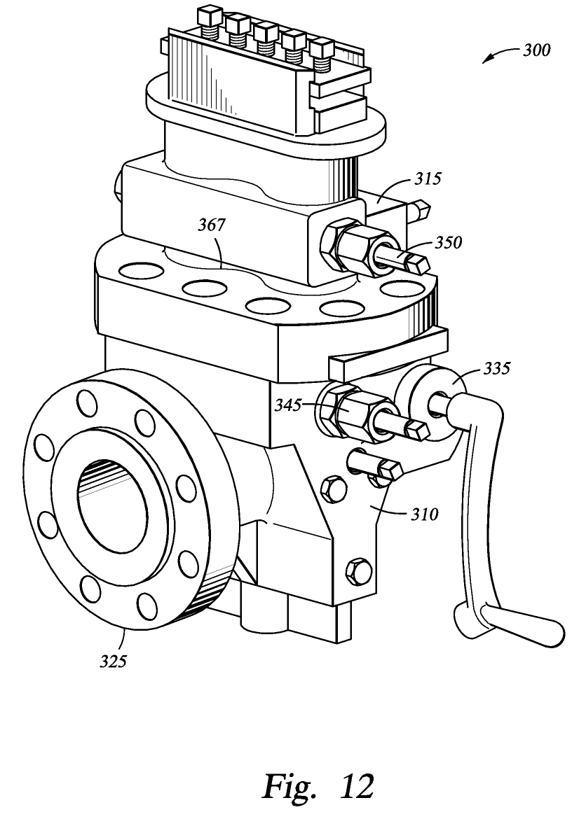

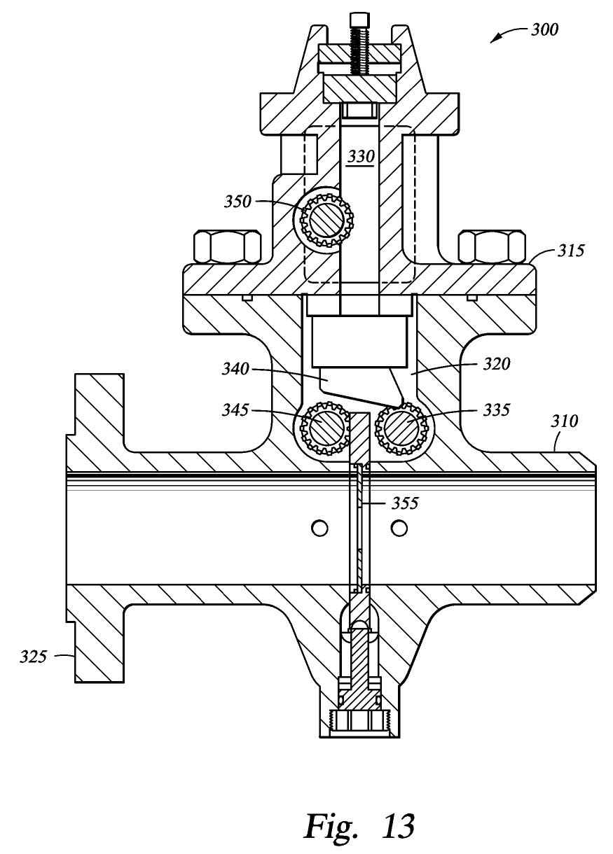

Referring now to FIGS. 12 and 13, an alternate embodiment of a dual chamber orifice fitting 300 is shown. Fitting 300 includes body 310 and top 315. Body 310 encloses lower chamber 320 and provides fluid communication with the interior of the pipeline by way of flange 325. Top 315 encloses upper chamber 330. Shaft 335 is used to open and close a valve assembly 340 that isolates lower chamber 320 from upper chamber 330. Valve assembly 340 is a slide-type valve as is known in the art and actuates by moving laterally across an aperture. Shafts 345 and 350 are used to move orifice plate carrier 355 between lower chamber 320 and upper chamber 330. FIGS. 8 and 9 illustrate that fittings with curved chambers can be adapted to different styles of valve fittings including plug valves, slide valves, ball valves and other types of dual and single chamber orifice fittings.

The previously described embodiments include upper and lower chambers that have curved cross-sections. In certain embodiments, the cross-sections are a curve with inner and outer radii, a Cassini oval or a dog-bone shape. It is also understood that the chambers may not have a consistent cross-section over their entire length. It may be desirable to vary the cross-section of the chamber and/or wall in order to compensate for penetrations through the wall or to accommodate internal equipment.

One important aspect of the invention is the use of curved upper and/or lower chambers as disclosed herein, which provides several benefits over convention rectangular and curved cross-section chambers. The curved cross-section of the chambers provide a more uniform stress distribution through the wall surrounding the chamber than would be possible with a rectangular cross-section, while not significantly reducing wall strength by the addition of reduced portions such as at 467. By effectively managing this stress distribution, acceptable stress levels can be maintained with a thinner wall structure. A thinner wall structure requires less material and the overall weight of the fitting can be reduced. The reduced width or footprint of the chambers and flanges as disclosed herein also requires less material, and eases dimensional containment issues with the fitting. A lighter fitting reduces the costs of procuring and manufacturing the fitting. The curved wall structure also minimizes deflection of the wall under pressurized conditions, which gives greater reliability and allows for closer tolerances between the chamber wall and the interior components. If particularly high pressure applications are needed, a rib such as at 468 of FIG. 7 may be added to reinforce the side parallel to major axis A₁.

The curved wall, particularly the recessed portions, also allows the bolts that connect the flanges on the top and body components to be evenly and perhaps linearly spaced for easier access. Controlling the thickness of the wall and recessing the wall allows for sufficient space to be provided around each bolt location to provide access to wrenches and other torque-applying tools, while also maintaining a smaller fitting.

The curved chamber also provides advantages in the manufacturing of the top and the body. Conventionally, the top and body are cast components. When being cast, an insert is used to form the chamber within the components. Because the conventional chamber has a relatively thin rectangular cross-section, the insert used to form the chamber is susceptible to warping or moving due to the intense heat of the casting process. This warping or moving caused inconsistent castings and added complexity to the manufacturing process. The larger curved cross-section chamber requires a larger insert to form and is thus less susceptible to casting defects. In addition, the minor sides of the curved cross-section are reduced or taken in such that the curved cross-section is not unnecessarily large.

The embodiments relate to apparatus for housing a dual chamber orifice fitting but the concepts of the invention are susceptible to use in embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. In particular, various embodiments of the present invention provide a number of different body shapes and styles to improve stress distribution through the body and reduce its footprint. Reference is made to the application of the concepts of the present invention to dual chamber orifice fitting with a plug valve arrangement, but the use of the concepts of the present invention is not limited to these applications, and can be used for any other applications including other dual chamber fittings, including slide valve fittings, tapered valve fittings, ball valve fittings and other orifice fittings utilizing rectangular orifice plate carriers. It is to be fully recognized that the different teachings of the embodiments discussed below may be employed separately or in any suitable combination to produce desired results.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A fitting comprising:
a body portion having a lower chamber in fluid communication with a pipeline;
a top portion connected to said body portion via an upper flange that is coupled to a lower flange disposed on said body portion; and
an upper chamber disposed within said top portion and in fluid communication with the lower chamber, wherein at least a portion of either the upper chamber or the lower chamber has a cross-section with an inner radius and an outer radius, wherein the cross-section is taken parallel to the upper and lower flanges.

2. The fitting of claim 1 further wherein the cross-section includes an oval.

3. The fitting of claim 2 wherein said oval is a Cassini oval.

4. The fitting of claim 2 wherein said oval includes a dog-bone shape.

5. The fitting of claim 2 wherein said oval includes a semi-minor axis that is less than the greatest semi-latus rectum along a major axis of said oval.

6. The fitting of claim 5 wherein a semi-latus rectum greater than said semi-minor axis is disposed on each side of said semi-minor axis along said major axis.

7. The fitting of claim 1 further comprising:
a valve adapted to isolate the upper chamber from the lower chamber; and
a plate having an orifice, wherein said plate is selectably disposable in either the upper or lower chamber.

8. The fitting of claim 7 wherein said plate has a first position where said plate is within the lower chamber and a second position wherein said plate is within the upper chamber.

9. The fitting of claim 8 wherein the orifice is aligned with the pipeline when said plate is in the first position.

10. The fitting of claim 1 wherein said upper and lower flanges have corresponding bolt patterns with inner and outer radii.

11. The fitting of claim 1 wherein the top portion further comprises a double curved wall surrounding the upper chamber, wherein the double curved wall is curved about an axis that is perpendicular to the upper flange.

12. The fitting of claim 1 wherein the body portion further comprises a double curved wall surrounding the lower chamber, wherein the double curved wall is curved about an axis that is perpendicular to the lower flange.

13. A fitting comprising:
a body portion having a lower chamber in fluid communication with a pipeline;
a top portion having an upper chamber in fluid communication with the lower chamber; and
an upper flange disposed on said top portion and coupled to a lower flange disposed on said body portion;
wherein at least a portion of either the upper chamber or the lower chamber has a cross-section including a Cassini oval.

14. The fitting of claim 13 wherein at least one plane parallel to the lower flange and through the lower chamber defines said Cassini oval.

15. The fitting of claim 13 wherein at least one plane parallel to the upper flange and through the upper chamber defines said Cassini oval.

16. The fitting of claim 15 further comprising a wall having a substantially constant thickness surrounding the portion of the upper chamber having the cross-section including said Cassini oval.

17. The fitting of claim 16 further comprising a wall having a substantially constant thickness surrounding the portion of the lower chamber having the cross-section including said Cassini oval.

18. The fitting of claim 13 further comprising an orifice plate carrier selectably disposable in either the lower chamber or the upper chamber, wherein said orifice plate carrier has a rectangular cross-section.

19. A fitting comprising:
a body portion having a lower chamber in fluid communication with a pipeline;
a top portion having an upper chamber in fluid communication with the lower chamber; and
an upper flange disposed on said top portion and coupled to a lower flange disposed on said body portion;
wherein at least a portion of either the upper chamber or the lower chamber has a cross-section including a dog-bone shape.

20. The fitting of claim 19 further comprising:
a valve adapted to isolate the upper chamber from the lower chamber; and
a plate having an orifice, wherein said plate is selectably disposable in either the upper or lower chamber.

21. The fitting of claim 19 wherein at least one plane parallel to the lower flange and through the lower chamber defines a first dog-bone shape, and at least one plane parallel to the upper flange and through the upper chamber defines a second dog-bone shape.

22. The fitting of claim 21 further comprising:
a double curved wall surrounding the upper chamber; and
a double curved wall surrounding the lower chamber.

23. The fitting of claim 22 wherein the double curved walls have inner and outer curved surfaces.
